(19) United States
(12) Patent Application Publication
(10) Pub. No.: US 2002/0138288 A1
(43) Pub. Date: Sep. 26, 2002

(54) Internet based directory system

(76) Inventor: Jonathan A. Kurpis, Ridgewood, NJ (US)

Correspondence Address: Martin B. Pavane ESQ, Cohen Pontani Lieberman & Pavane, 551 Fifth Avenue, Suite 1210, New York, NY, 10176, US

(21) Appl. No.: 09/885,423

(22) Filed: Jun. 20, 2001

Related U.S. Application Data
(60) Provisional application No. 60/212,858, filed on Jun. 20, 2000.

(51) Int. Cl. G06F 17/60

(52) U.S. Cl. 705/1

(57) ABSTRACT

A system and method for providing users with referrals to providers over the Internet. Each geographic area, or zone, is allocated exclusively to one provider, thus eliminating listing problems. The user navigates, using an easy point-and-click interface, to the zone where the user is located through a hierarchy of map web pages maintained at the referral system web server. When the appropriate zone is selected, the web page of the exclusive provider in the user's zone is displayed to the user.

### RELATED APPLICATIONS

This application claims priority from U.S. Provisional Patent Application Serial No. 60/212,858 which was filed on Jun. 20, 2000, which is hereby incorporated by reference.

### BACKGROUND OF THE INVENTION

1. Field of the Invention

The present invention relates generally to Internet referral services and, in particular, to a system and method for providing an Internet user with a referral to a provider of goods and/or services based on the geographic location of the Internet user.

2. Description of the Related Art

The use of the Internet as an information source for consumer decisions has greatly increased in the past years. One type of Internet consumer information source is a referral service in which, based on a geographic location of the Internet user, the service will provide the Internet user with the name of one or more providers of a service and/or product. Such existing “referral services” usually store contact information, such as business name, address, zip code, etc., in a master directory or database. When a user interfaces with the website of the referral service, this contact information is presented to the user.

The present architecture and design offered by Internet referral directories can be classified as either General or Semi-Exclusive. In the General (or Non-Exclusive) referral service, any provider who is willing to pay or sign up will be added to the referral listing. In the Semi-Exclusive referral service, the number of providers of a particular service and/or product will be limited by some parameter, such as limiting the number of ophthalmologists listed in a specific region to a particular percentage of the total number of ophthalmologists in that specific region.

However, there are various problems with these conventional Internet referral directories. First, there are often inconsistent referral results. There may be no listings offered to the user at all. This may result from the geographic areas being used by the referral service being too specific or too small. For example, if the referral service offers referrals based on the zip code or area code of the user, there might not be a provider in that one area; however, there may be a provider within a few miles of the user whom the service does not identify because the provider is not in the user's zip code or area code. Second, there may be too many listings offered to the user. This may overwhelm the user and cause the user to not select any providers at all. Even if the user does use the referral service, he or she may find it unpleasant to wade through the similar listings and, because it was not a favorable experience, he or she will not recommend the referral service to others and will not return to use the referral service again.

The large listing phenomena is also a problem for the listed providers because of the inconsistency of exposure. If the list must be scrolled through, the providers referred on the top of the list naturally get more attention than the providers at the bottom (a problem that exists in conventional telephone directories). For some lists, the majority of providers may in fact be off-screen. For example, if the list is alphabetical, the businesses beginning with the letters g-z may require additional steps (such as scrolling) to be seen. Even if the list is randomized, the problem is not solved, merely spread out randomly to the providers. Furthermore, implementing the list as multiple pages or frames does not alleviate the problem.

Third, many referral services require the user to fill out a form in order to access their listings. The form usually requires personal information, such as the user's name, address, telephone number, or e-mail address. Besides taking additional time and effort, this requirement is often considered invasive by the user. Fourth, and related to the third, the amount of work that is required before the user reaches the listings may be a problem. Often the user must navigate and click through many pages of web content before reaching the desired information. This is burdensome and may result in the user not persevering long enough to receive the desired listings.

Therefore, there is a need for a system and method to provide a referral service which does not give the user too many or too few listings. In addition, the system and method should not require personal information from the user nor require too much effort on the user's part to get the desired listings.

### SUMMARY OF THE INVENTION

One object of the present invention is to provide a referral service system and method that does not give the user too many or too few listings.

Another object of the present invention is to provide a referral service system and method that does not require personal information nor too much effort from the user.

These and other objects are accomplished by the present invention. In one aspect, the presently preferred embodiment comprises a method for providing a referral service website. In the method, after a super-region over which the referral service will offer referrals is selected, it is divided into zones. Then, a hierarchy of intermediate level regions from the super-region down to the zones is created. Map web pages are constructed for the super-region and each region in the hierarchy of intermediate level regions. Each x-level intermediate map displays a plurality of regions of an x+1 intermediate level and each displayed region of the plurality of regions is a selectable hyperlink that leads to one of a corresponding x+1 intermediate level map web page and a provider web page. Each zone is allocated to a provider, and provider web pages are constructed. Lastly, the referral service website, including at least one of the map web pages and the provider web pages, is put online for users to access.

In another aspect, the presently preferred embodiment comprises a method by which a user navigates a referral service website. In the method, the referral service website first displays a super-region map screen to the user, where the user selects an x intermediate level region by clicking on an area of the displayed map screen representing the x intermediate level region. The selected x intermediate level region map is displayed to the user. The user then selects an x+1 intermediate level region by clicking on an area of the displayed x intermediate level region map screen representing the x+1 intermediate level region. If the x+1 intermediate level region is not a zone, an x+1 intermediate level region map is displayed to the user and the process repeats. If the x+1 intermediate level region is a zone, a provider web page is displayed to the user, wherein the provider is an exclusive provider for the zone.

In still another aspect, the presently preferred embodiment comprises a referral service system for providing a user with a referral to a provider of at least one of a service and a product. This referral service system maintains a hierarchy of map web pages, with a top level, one or more intermediate levels, and a bottom level. The top level is a single super-region map web page with hyperlinks to the first intermediate level map web pages. Each intermediate level is comprised of a plurality of intermediate level maps with hyperlinks to the intermediate levels beneath it. The bottom level is a plurality of intermediate level maps with hyperlinks to provider web pages. In the hierarchy, an x intermediate level region map web page displays a plurality of x+1 intermediate level regions and each of said plurality of x+1 intermediate level regions comprises a hyperlink to an x+1 intermediate level region map web page. A referral service web server provides access to the hierarchy of map web pages to the user, and a network carries communications, including the map web pages, between the user and the referral service web server. The user has a computing means capable of running a web browsing program and equipped with a display, wherein said computing means is connected to said network and receives map web pages from said referral service web server.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a schematic representation of an exemplary network where a referral service system and method are implemented according to the presently preferred embodiment of the present invention;

FIG. 2A shows a Graphical User Interface (GUI), in particular a State Selection Screen, for a display according to the presently preferred embodiment of the present invention;

FIG. 2B shows a Textual Based Interface, in particular a State Selection Screen, for a display according to the presently preferred embodiment of the present invention;

FIG. 3 shows a Region Selection Screen GUI for a display according to the presently preferred embodiment of the present invention;

FIG. 4 shows a Provider Page GUI for a display according to the presently preferred embodiment of the present invention;

FIG. 5 shows a multilevel selection screen hierarchy according to the presently preferred embodiment of the present invention;

FIG. 5B is an exemplary representation of the hierarchical structure of map web pages;

FIG. 6A is a flowchart of a method for setting up a referral service system according to the presently preferred embodiment of the present invention;

FIG. 6B is a flowchart of a method for a user to access a referral service system according to the presently preferred embodiment of the present invention;

FIGS. 7A and 7B show how the shape of one or more zones may be customized according to the presently preferred embodiment of the present invention;

FIGS. 8A and 8B also show how the shape of one or more zones may be customized according to the presently preferred embodiment of the present invention.

### DETAILED DESCRIPTION OF THE PRESENTLY PREFERRED EMBODIMENT

The presently preferred embodiment of the present invention is a referral directory system and method that guarantees exclusive zones of equal population size to providers of services and/or goods while presenting a user-friendly interface for users of the directory to quickly and efficiently obtain referrals for themselves. Unlike previous referral systems, each zone in the presently preferred embodiment has only one provider, thus eliminating listing problems. Furthermore, the user has a simple and intuitive point-and-click interface by which the user obtains referral information from the referral system.

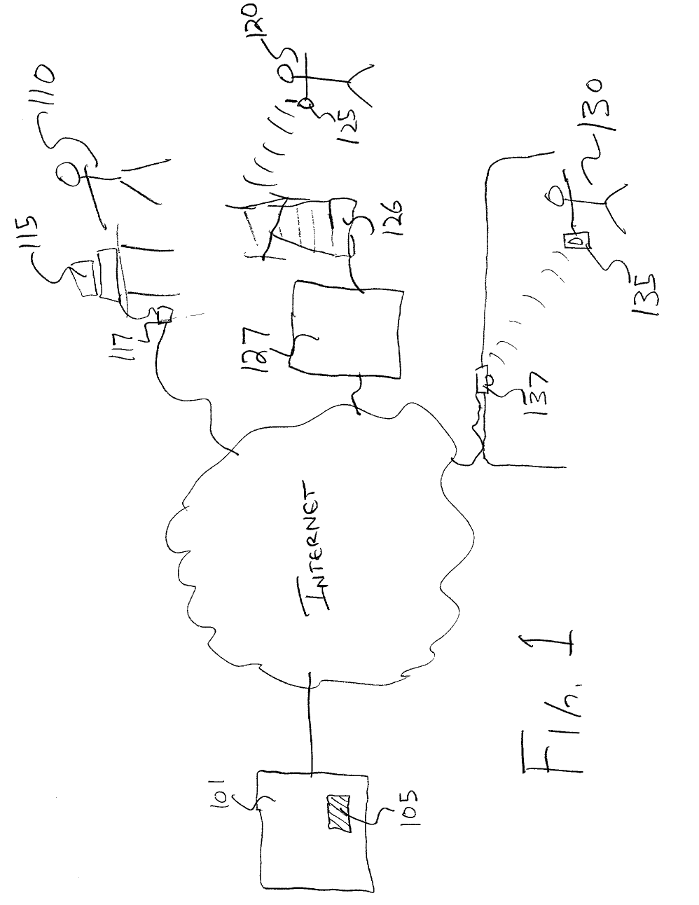

FIG. 1 is a schematic representation of an exemplary network in which the presently preferred embodiment is implemented. In FIG. 1, a Referral System 101 is shown connected to the Internet 120. A user 110 accesses the Internet 120 by a modem 117 connection to a personal computer (PC) 115. PC user 110 has a web browser program installed on PC 115, and uses the web browser program to access web pages provided by a Referral System Web Server 105 at Referral System 101. Referral System 101 may comprise any number of web servers, databases, and other servers in order to maintain the referral service for the users. The large variety of ways to implement such a system in hardware and/or software will not be described here, as it is beyond the scope of the present invention.

The term “web server” is to be understood as a World Wide Web-type server that delivers web pages to client browsers. It is not necessary for a web server or a web browser to be connected to the Internet, and any network can connect them to each other. In the presently preferred embodiment, the web pages are in HTML (HyperText Mark-up Language), but any mark-up language may be used as long as it is decipherable by the client browsers being used on the network. Although the presently preferred embodiment uses a web server, any network server system that provides individual graphic and/or text files that can provide links to other graphic/text files could be used. Thus, other embodiments may use another type of interface server and interface client.

User 120 has a cellular telephone 125 that is web-enabled. Cellular telephone 125 can access the Internet 120 by means of base station 126 and cellular phone system 127. Cellular telephone 125, cellular phone system 127, and Referral System 101 use the Wireless Access Protocol (WAP) in order to provide a communication link over the Internet 120 from cellular telephone 125 to Referral System 101. Cellular telephone 125 has a modified web browser program by which user 120 may access referral information at Referral System 101. Another user 130 has a personal digital assistant (PDA) 135 which has a communication link with a wireless Local Area Network (LAN) 137, which is connected to the Internet 120. Through this communication link, PDA user 130 can access referral information at Referral System 101 by means of a web browser program on PDA 135.

Although FIG. 1 gives the examples of a PC, a cellular telephone, and a PDA, any means capable of maintaining a connection with the Referral System 101 over the Internet 120 and capable of running a web browser program may be used in embodiments of the present invention.

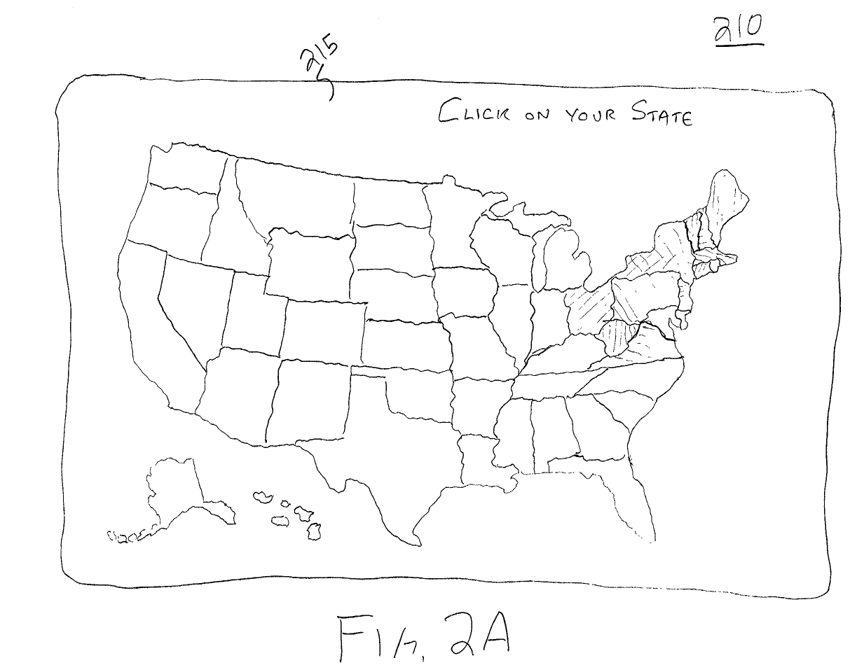

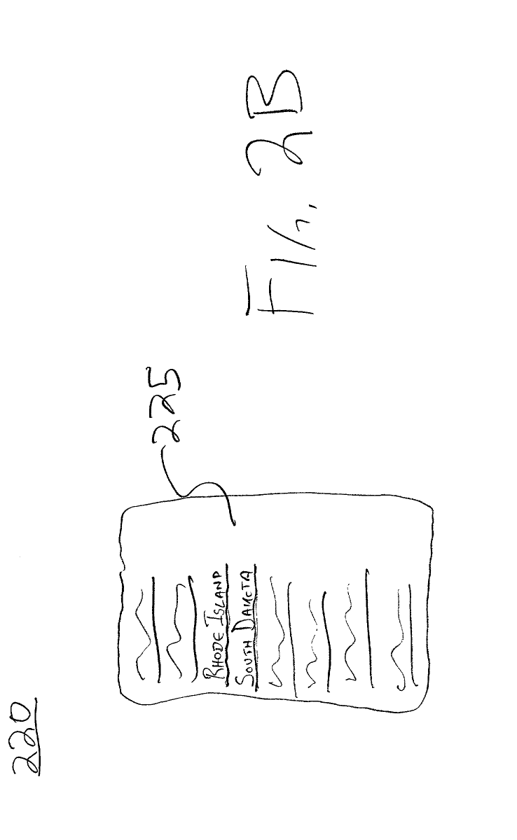

FIGS. 2A and 2B show the two types of User Interfaces (UIs) that may be used in the presently preferred embodiment of the present invention. In FIG. 2A, the Graphical User Interface (GUI) 210 provides an image of the entire country with each state demarcated by lines. In GUIs that are capable of displaying colors, each state will also have a color distinguishing it from its neighbors, which is shown in FIG. 2A by the various hatching marks. The State Selection Screen 215 is the first screen that the user encounters at the referral service website. At this screen, the user selects her state in any known manner, such as pointing a screen cursor and clicking with a mouse or other interface device. The screens following this one are also constructed so that the user need only click upon an area of the screen or an icon in order to select or enter information. In this way, the user may provide locational information with the least amount of effort, and without the feeling that personal information has been divulged.

In FIG. 2B, the Textual User Interface 220 provides textual hyperlinks for each state in its State Selection Screen 225, so that clicking on the name of any state will effectively select that state. The Textual User Interface may also consist of an area on the screen, such as a box or command prompt, where the user may manually enter the name of the state. GUI 210 of FIG. 2A would be appropriate as the web browser interface in PC 115, or perhaps PDA 135, of FIG. 1, whereas Textual User Interface 220 of FIG. 2B would be appropriate for either a computationally limited or a display limited device, such as cellular telephone 125 in FIG. 1. Although it is possible to use Textual User Interfaces for the screens following the State Selection Screen, in the following description, the screens will be shown as GUIs for convenience.

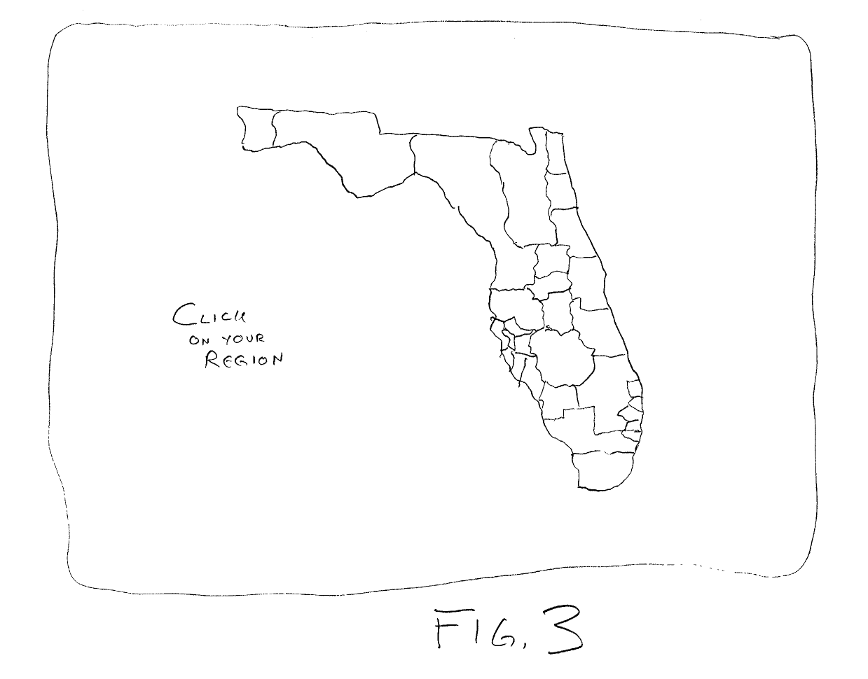

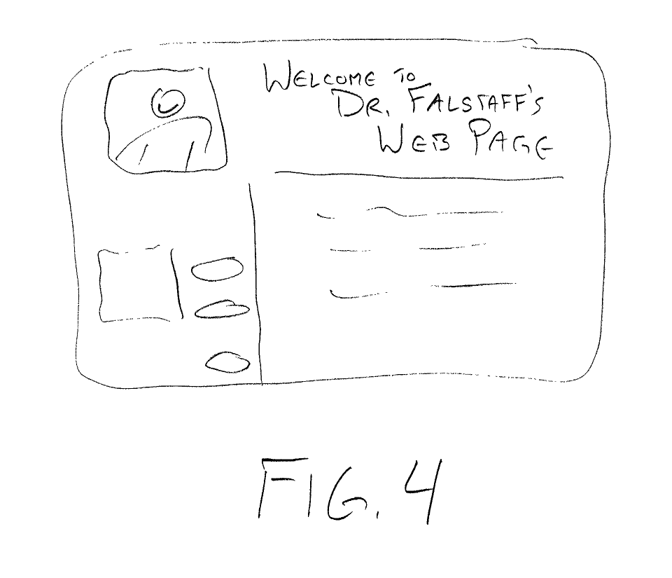

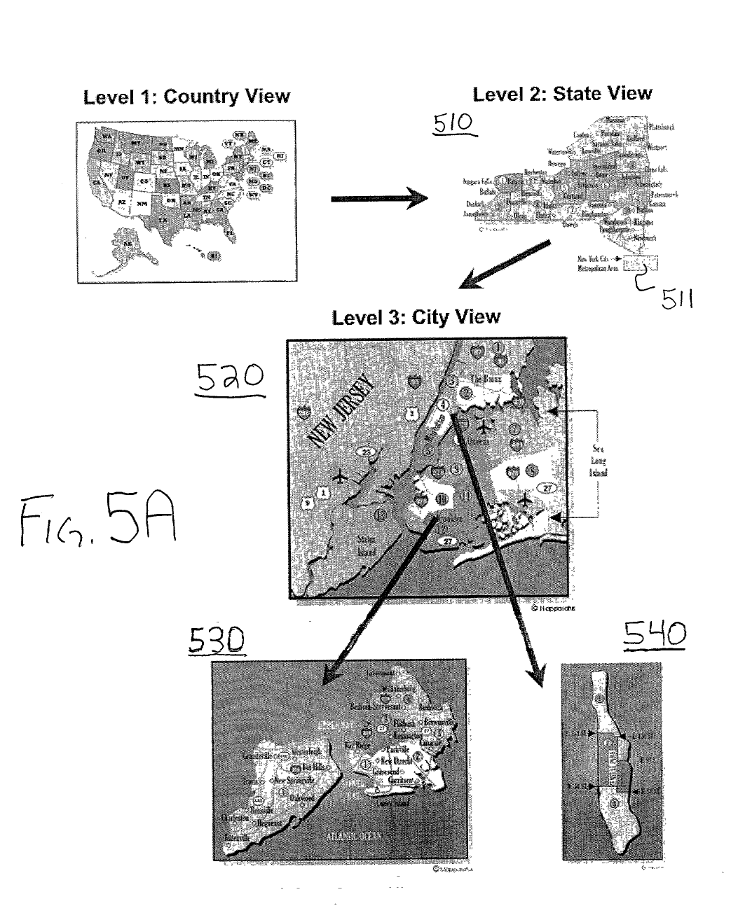

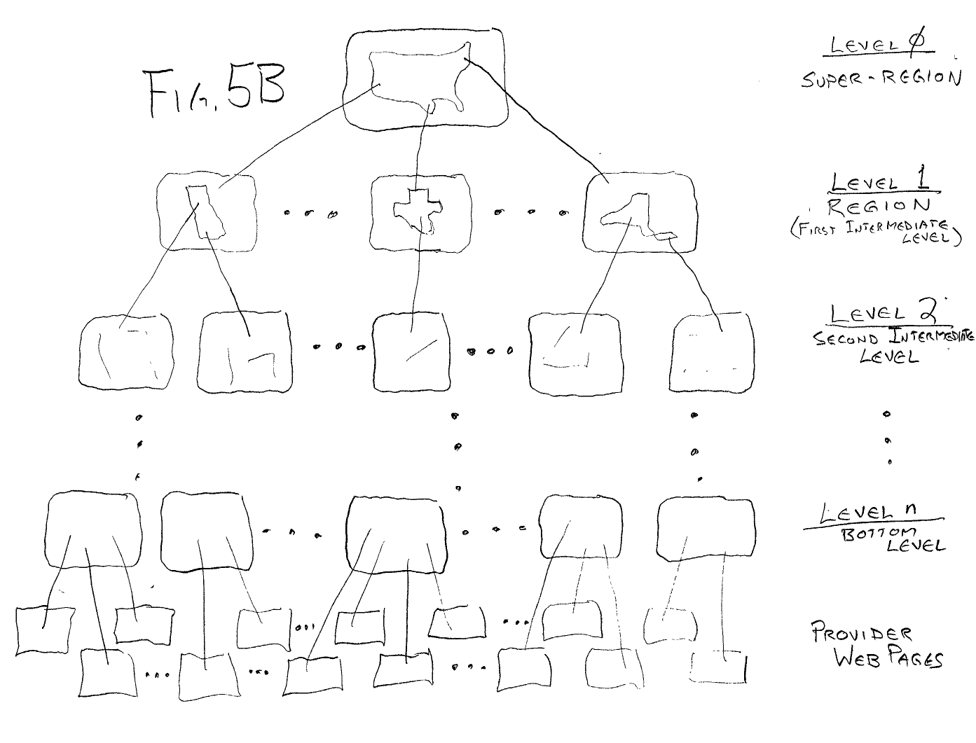

After selecting her state at the state selection screen, the user is presented with another screen, the Region Selection Screen 310 as shown in FIG. 3. On this screen, the state is divided or segregated into separate regions and the user once again selects her location by clicking on the appropriate area of the screen which represents her region. In the presently preferred embodiment of the present invention, when the user selects the appropriate region, the next screen that pops up is a Provider Page 410 describing the provider for that particular region, such as is shown in FIG. 4. However, in areas of condensed population, there might be several screens before reaching a Provider Page. For example, in FIG. 5A, the greater metropolitan area of a city such as New York may appear as one region 511 in the Region Selection Screen 510, but, when that one region 511 is clicked by the user, another selection screen (the second intermediate level region map page; in this case, City View 520) may pop up. City View 520 has the boroughs of N.Y. (Manhattan, Brooklyn, the Bronx, Queens, and Staten Island) as separate selectable regions. And, because of the large populations in those boroughs, it is possible that, even after selecting a borough in City View 520, one or more selection screens (third intermediate level region map pages and so on), such as Staten Island/Brooklyn 530 or Manhattan 540, would appear before the user reaches a Provider Page. FIG. 5B is an exemplary representation of the hierarchical structure of the map web pages.

The area, or zone, over which a provider is the exclusive provider in the referral system can be based on governmental boundaries (such as counties, boroughs, or cities), geographical boundaries (such as valleys, islands, or hills), or system boundaries (such as area codes or zip codes). In the presently preferred embodiment, none of these boundaries are used, because they result in zones with unequal populations. Instead, each region is broken into separate zones that consist of equal populations. The population size per zone in the presently preferred embodiment is 500,000, although other embodiments may use other sizes. The selection of the area comprising the 500,000 may involve other considerations, including governmental, geographical, or system boundaries.

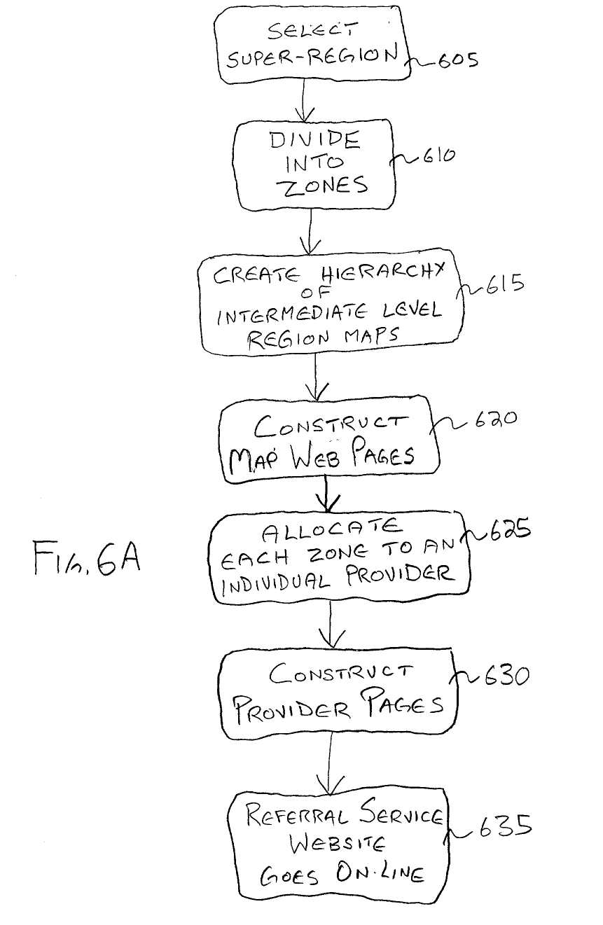

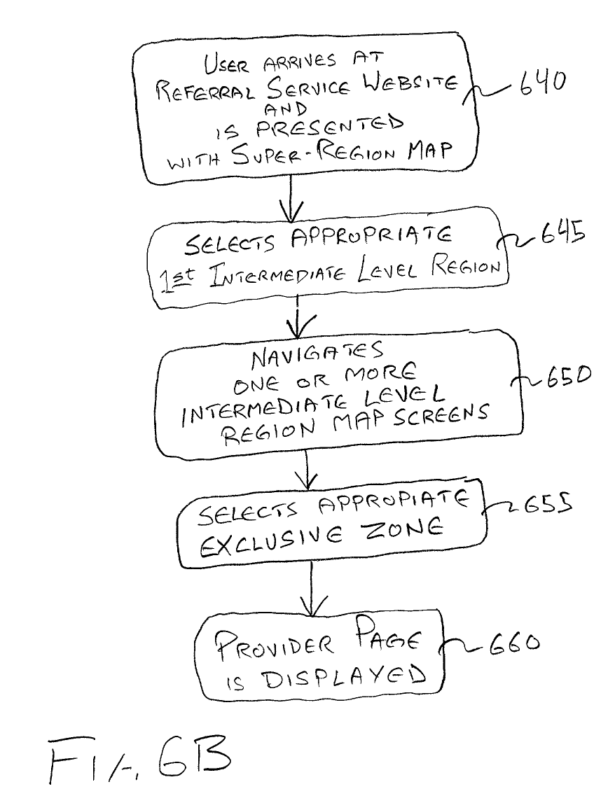

A method for setting up a referral service system according to the presently preferred embodiment of the present invention is shown in FIG. 6A. In step 605, a “super-region”, the largest map unit, is chosen. In the presently preferred embodiment, the super-region is the country of the United States. The super-region is divided into zones in step 610. Each zone will be the exclusive area for a single provider. In the presently preferred embodiment, each zone is selected on the basis of equal population (500,000). Various decisions about the parameters of division may be made in this step. For instance, it may be decided that zones will not extend from one state to a neighboring state, which will make it convenient for users to find providers in their own state.

After dividing the super-region into zones in step 610, the zones are collected together to form a hierarchy of intermediate levels between the super-region map and the individual zones in step 615. In the presently preferred embodiment of the present invention, it is preferred to have only one intermediate region map (the Region Selection Screen) between the super-region map (the State Selection Screen) and an individual zone (which, when clicked in the Region Selection Screen, will display a Provider Page). This is preferable because of the ease and convenience it provides the user, who, after arriving at the referral system website, will only be three point and clicks away from a referral. However, as shown in FIG. 5A above, it may be necessary to have more than one intermediate level between the super-region and the individual zones.

In step 620 of FIG. 6A, web pages representing the hierarchy of maps from the super-region down to the zones are constructed. Each map page is constructed with hyperlinks to the appropriate regional map pages above and below it in the hierarchy of maps. As discussed above, these hyperlinks are represented by sectional map images which may be selected by the intuitive point-and-click method. Having effectively created the referral service website in steps 605-620, each exclusive zone is now allocated, on a contractual basis, to individual providers in step 625. Of course, this step may occur at any time, even before step 605. In fact, many of these steps may be performed in a different order or simultaneously. The contractual basis of the allocation is open to a wide variety of implementations, from outright sale to periodic lease. In the presently preferred embodiment of the present invention, the contractual basis is a one-year service contract in which the referral service maintains the Provider Page on behalf of the provider. In other embodiments, the exclusive zone hyperlinks may jump to a Uniform Resource Locator (URL) of an independent website which is maintained by the provider.

In step 630 of the method according to the presently preferred embodiment, the Provider Pages are constructed by the referral service. As indicated above, in other embodiments, this may be performed by the providers on an individual basis. Lastly, the website is put online in step 635, thus allowing the public to have access to the referral service.

A method for a user to access a referral service system according to the presently preferred embodiment of the present invention is shown in FIG. 6B. In step 640, the user arrives at the referral service website and is presented with the super-region map screen. The user selects the appropriate first intermediate level region by pointing and clicking in step 645. Next, the user navigates the one or more intermediate level map screens by pointing and clicking the appropriate region at each screen in step 650, until the user selects a zone in step 655. At this point, the Provider Page of the exclusive provider for that zone is displayed to the user in step 660 and the procedure ends. In other embodiments, the user has the option of using a system code, such as a zip code or area code, to quickly jump to the appropriate Provider Page.

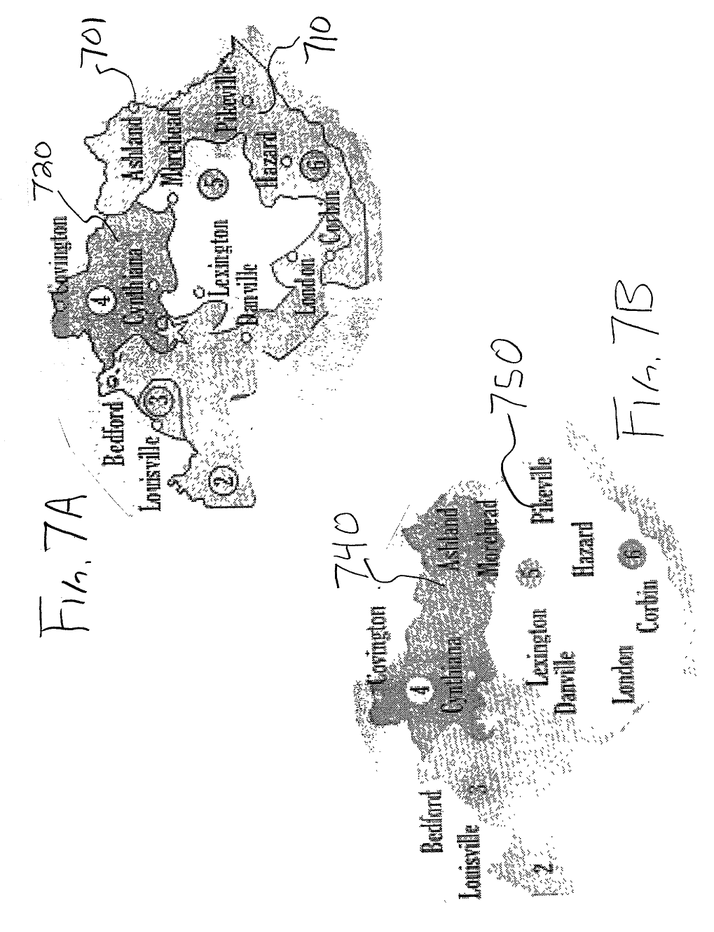

In cases where the zones, although substantially equal in population, are very irregular in shape, individual customization is possible. For example, as shown in FIG. 7A, a provider 701 that wishes to join the referral service is located in Ashland, Ky. However, provider 701 is not happy with the coverage that would be provided by his zone, Zone 6 710. Provider 701 feels that Zone 6 710 is not practical for attracting new clients, and his current clientele is drawn more from Zones 4 720 and 5 730 than his Zone 6 710. In addition to its impracticality and unappealing appearance, the odd shape of Zone 6 730 may confuse users. Thus, in this case, Zone 6 710 of FIG. 7A is eliminated in favor of the more practical enlarged Zones 4 740 and 5 750, as shown in FIG. 7B. This change is beneficial for both the user and the provider.

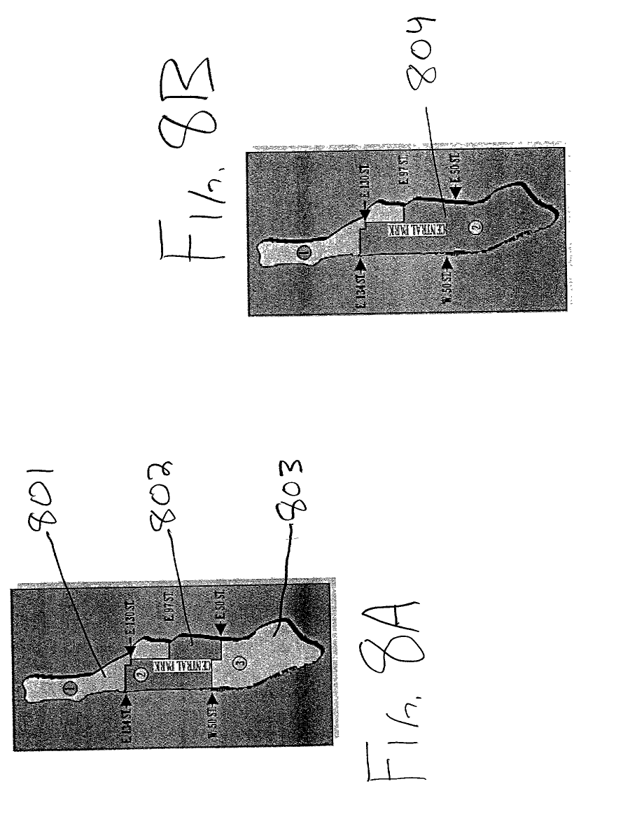

As another example, a provider may want to be the exclusive provider in more than one zone. In this case, these zones may be combined to form a single, larger zone, as shown in FIGS. 8A and 8B. In FIG. 8A, the island of Manhattan is divided into three zones—Zones 1 (801), 2 (802), and 3 (803). The provider in Zone 3 (803) decides to buy Zone 2 (802) in addition to Zone 3 (803). In addition, the provider wants a single colored zone presented in the map screen in order to make it appear more attractive as well as easier for the user to navigate. Thus, in FIG. 8B, Zones 2 (802) and 3 (803) of FIG. 8A have been combined to form a new Zone 2 (804).

In conclusion, the present invention provides substantial advantages over the prior art referral systems. First, each listing is exclusive for a specific area, thus providing guaranteed exclusive exposure to the provider while also providing simplicity and clarity to the user. Second, the map GUIs provide an intuitive and clear display of area choices from which the user may select, as well as providing a user-friendly point and click environment. Third, the equal population-based zones guarantee both a balanced division of exclusive zones and a reasonably-sized potential consumer base from which the provider may build. Fourth, the ability to customize the zones to the individual circumstances of the region or the provider provides great flexibility both in selling and in presenting the exclusive zones.

While there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for providing a referral service website, wherein users are referred to providers of at least one of a service and a product, comprising the steps of:
selecting a super-region over which the referral service will offer referrals;
dividing the super-region into zones;
creating a hierarchy of intermediate level regions from the super-region down to the zones;
constructing map web pages for the super-region and each region in the hierarchy of intermediate level regions, wherein each x-level intermediate map displays a plurality of regions of an x+1 intermediate level and each displayed region of the plurality of regions is a selectable hyperlink that leads to one of a corresponding x+1 intermediate level map web page and a provider web page; and
allocating each zone to a provider.

2. The method as recited in claim 1, wherein the super-region is a country.

3. The method as recited in claim 1, wherein the zones into which the super-region is divided are based on equal population.

4. The method as recited in claim 3, wherein the equal population of each zone is one of 100,000, 250,000, and 500,000.

5. The method as recited in claim 1, wherein the step of creating a hierarchy of intermediate level regions from the super-region down to the zones comprises the step of:
creating a single intermediate level between the super-region and the zones so that a user at the referral service website need only select two hyperlinks starting at the super-region map web page before reaching a provider web page.

6. The method as recited in claim 1, further comprising the step of:
maintaining the provider web page at the service referral website.

7. The method as recited in claim 1, further comprising the step of:
maintaining, by a provider, the provider web page.

8. A method by which a user navigates a referral service website, wherein users are referred to providers of at least one of a service and a product, comprising the steps of:
a) displaying a super-region map screen to the user;
b) selecting, by the user, an x intermediate level region by clicking on an area of the displayed map screen representing the x intermediate level region;
c) displaying an x intermediate level region map to the user;
d) selecting, by the user, an x+1 intermediate level region by clicking on an area of the displayed x intermediate level region map screen representing the x+1 intermediate level region;
e) displaying an x+1 intermediate level region map to the user, if the x+1 intermediate level region is not a zone, and returning to step (b) wherein x is now equal to x+2; and
f) jumping to a web page of a provider, if the x+1 intermediate level region is a zone, wherein the provider is an exclusive provider for the zone.

9. The method as recited in claim 8, wherein there is only one intermediate level region map screen so that a user need only select two hyperlinks starting from the super-region map web page before reaching a provider web page.

10. The method as recited in claim 8, further comprising:
maintaining, by one of the provider and the service referral website, the provider web page.

11. A referral service system for providing a user with a referral to a provider of at least one of a service and a product, comprising:
a hierarchy of map web pages, wherein said hierarchy comprises:
a top level comprised of a single super-region map web page;
at least one intermediate level comprised of a plurality of intermediate level maps, wherein the super-region map web page has hyperlinks to each of first intermediate level map web pages; and
a bottom level comprised of a plurality of intermediate level maps with hyperlinks to provider web pages;
a referral service web server for providing a user with access to the hierarchy of map web pages;
a network for carrying communications including map web pages between the user and the referral service web server; and
a computing means capable of running a web browsing program and equipped with a display, wherein said computing means is connected to said network and receives map web pages from said referral service web server;
wherein an x intermediate level region map web page displays a plurality of x+1 intermediate level regions and wherein each of said plurality of x+1 intermediate level regions comprises a hyperlink to an x+1 intermediate level region map web page.

12. The system as recited in claim 11, wherein the computing means comprises one of a personal computer (PC), a cellular telephone, a portable laptop computer, a personal digital assistant (PDA), and a pager.

13. The system as recited in claim 11, wherein the network comprises at least one of the Internet, a cellular telephone system, a wired telephone system, a wired local area network (LAN), a wireless LAN, a cable television (CATV) system.
